(19) United States
(12) Patent Application Publication
(10) Pub. No.: US 2023/0246764 A1
(43) Pub. Date: Aug. 3, 2023

(54) DETERMINING PRESENCE OF UES HAVING LOW RADIO QUALITY AND ADJUSTING REFERENCE SIGNALS FOR USE BY THESE UES

(71) Applicant: Nokia Technologies Oy, Espoo (FI)

(72) Inventors: Daniela LASELVA, Klarup (DK); Nuno KIILERICH PRATAS, Gistrup (DK); Jorma KAIKKONEN, Oulu (FI)

(21) Appl. No.: 18/000,766

(22) PCT Filed: Jun. 26, 2021
(86) PCT No.: PCT/IB2021/055718

§ 371 Date: Dec. 5, 2022

Related U.S. Application Data
(60) Provisional application No. 63/047,557, filed on Jul. 2, 2020.

(51) Int. Cl. H04L 5/00; H04L 27/26

(52) U.S. Cl. CPC H04L 5/0048; H04L 5/0091; H04L 27/2675; H04L 5/0057

(57) ABSTRACT

A UE acquires information about a need of additional reference signals for synchronization purposes with cell(s), and sends to the cell(s), an indication that additional reference signals are needed for synchronization. The UE receives information of additional reference signal configuration to be used in the idle state or inactive state. The UE monitors for additional reference signals according to the additional reference signal configuration and uses the additional reference signals at least for synchronization purposes to synchronize with the cell(s). A cell in a wireless network sends information of additional reference signal configuration to be used by a UE while in either an idle state or an inactive state. The cell sends additional reference signals toward the UE according to the additional reference signal configuration.

### TECHNICAL FIELD

Exemplary embodiments herein relate generally to wireless communication networks and, more specifically, relates to determining presence of user equipment (UEs) in the wireless networks.

### BACKGROUND

A user equipment (UE) in a wireless network has a number of states into which it can be placed, including a Connected state, an Inactive state, and an Idle state. The Inactive and Idle states allow more power saving relative to the Connected state. However, the Inactive and Idle states do not allow nearly the connection options that are allowed by the Connected state. In particular, the Inactive and Idle states are also much more limiting than is the Connected state.

For instance, a UE in the Inactive state may be “camped on” a cell, meaning that the UE is not really “connected” to the cell, but instead has to go through a Random Access Channel (RACH) process before sending data. The UE may also be paged while in the Inactive state, and the UE has to wake up and examine a Paging Occasion (PO) in order to determine whether the UE is actually being paged. The paging indicates the cell and its corresponding network has data, possibly including a voice call, for the UE.

The UE has to synchronize with the cell in order to be able to receive the PO. That synchronization process, among other things, could be improved.

### BRIEF SUMMARY

This section is intended to include examples and is not intended to be limiting.

In an exemplary embodiment, a method is disclosed that includes transitioning by the user equipment to one of an idle state or an inactive state, and acquiring information by the user equipment about a need of additional reference signals for synchronization purposes with one or more cells. The method includes sending, by the user equipment and to the one or more cells, an indication that additional reference signals are needed for synchronization. The method further includes receiving, in the user equipment and in response to the sending, information of additional reference signal configuration to be used in the idle state or inactive state. The method also includes monitoring by the user equipment for additional reference signals according to the additional reference signal configuration and using the additional reference signals at least for synchronization purposes to synchronize with the one or more cells.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus to perform operations comprising: transitioning by the user equipment to one of an idle state or an inactive state; acquiring information by the user equipment about a need of additional reference signals for synchronization purposes with one or more cells; sending, by the user equipment and to the one or more cells, an indication that additional reference signals are needed for synchronization; receiving, in the user equipment and in response to the sending, information of additional reference signal configuration to be used in the idle state or inactive state; and monitoring by the user equipment for additional reference signals according to the additional reference signal configuration and using the additional reference signals at least for synchronization purposes to synchronize with the one or more cells.

An exemplary computer program product includes a computer-readable storage medium bearing computer program code embodied therein for use with a computer. The computer program code includes: code for transitioning by the user equipment to one of an idle state or an inactive state; code for acquiring information by the user equipment about a need of additional reference signals for synchronization purposes with one or more cells; code for sending, by the user equipment and to the one or more cells, an indication that additional reference signals are needed for synchronization; code for receiving, in the user equipment and in response to the sending, information of additional reference signal configuration to be used in the idle state or inactive state; and code for monitoring by the user equipment for additional reference signals according to the additional reference signal configuration and using the additional reference signals at least for synchronization purposes to synchronize with the one or more cells.

In another exemplary embodiment, an apparatus comprises means for performing: transitioning by the user equipment to one of an idle state or an inactive state; acquiring information by the user equipment about a need of additional reference signals for synchronization purposes with one or more cells; sending, by the user equipment and to the one or more cells, an indication that additional reference signals are needed for synchronization; receiving, in the user equipment and in response to the sending, information of additional reference signal configuration to be used in the idle state or inactive state; and monitoring by the user equipment for additional reference signals according to the additional reference signal configuration and using the additional reference signals at least for synchronization purposes to synchronize with the one or more cells.

In an exemplary embodiment, a method is disclosed that includes sending, by a cell in a wireless network, information of additional reference signal configuration to be used by a user equipment while in either an idle state or an inactive state. The method also includes sending by the cell additional reference signals toward the user equipment according to the additional reference signal configuration.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus to perform operations comprising: sending, by a cell in a wireless network, information of additional reference signal configuration to be used by a user equipment while in either an idle state or an inactive state; and sending by the cell additional reference signals toward the user equipment according to the additional reference signal configuration.

An exemplary computer program product includes a computer-readable storage medium bearing computer program code embodied therein for use with a computer. The computer program code includes: code for sending, by a cell in a wireless network, information of additional reference signal configuration to be used by a user equipment while in either an idle state or an inactive state; and code for sending by the cell additional reference signals toward the user equipment according to the additional reference signal configuration.

In another exemplary embodiment, an apparatus comprises means for performing: sending, by a cell in a wireless network, information of additional reference signal configuration to be used by a user equipment while in either an idle state or an inactive state; and sending by the cell additional reference signals toward the user equipment according to the additional reference signal configuration.

### BRIEF DESCRIPTION OF THE DRAWINGS

In the attached Drawing Figures:

FIG. 1 is a block diagram of one possible and non-limiting exemplary system in which the exemplary embodiments may be practiced;

FIG. 2 is a block diagram of a NR (5G) state machine, including state transitions;

FIG. 3 is an exemplary signaling flow showing exemplary embodiments;

FIG. 3A is an exemplary signaling flow similar to FIG. 3, but where the serving and target cells are both in (and formed by) a single gNB, in an exemplary embodiment; and

FIGS. 4 and 5 are logic flow diagrams performed by a user equipment and cell, respectively, and illustrate the operation of an exemplary method or methods, a result of execution of computer program instructions embodied on a computer readable memory, functions performed by logic implemented in hardware, and/or interconnected means for performing functions in accordance with exemplary embodiments.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as either “or”, “and”, or “both”.

The exemplary embodiments herein describe techniques for determining presence of UEs having low radio quality metrics such as low SINR and adjusting reference signals (RSs) for use by these UEs when, e.g., in Inactive or Idle states. Additional description of these techniques is presented after a system into which the exemplary embodiments may be used is described.

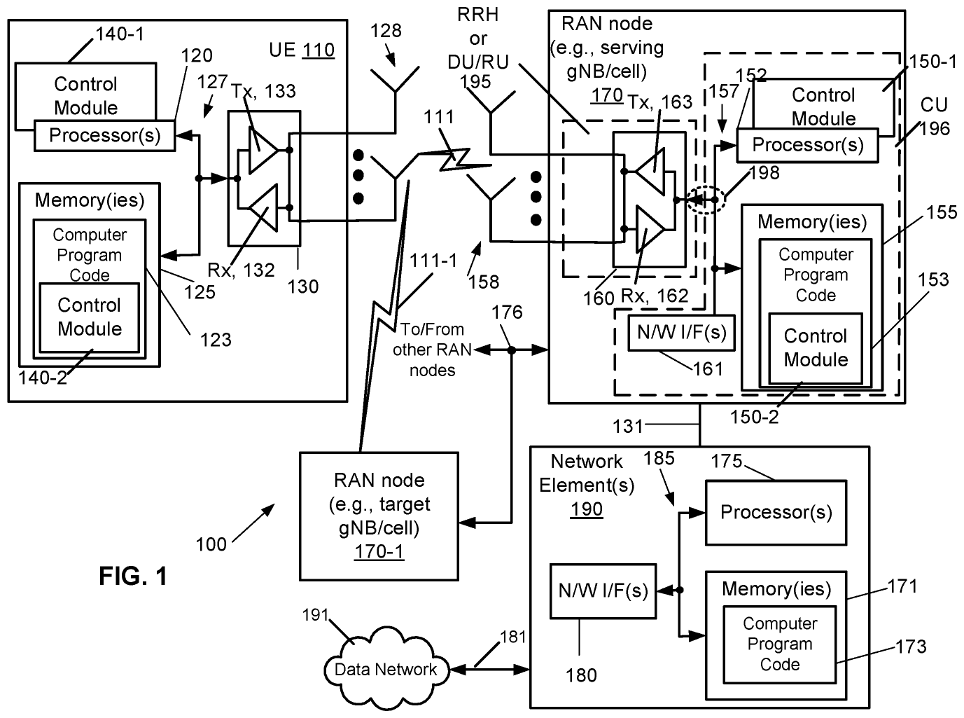

Turning to FIG. 1, this figure shows a block diagram of one possible and non-limiting exemplary system in which the exemplary embodiments may be practiced. A user equipment (UE) 110, radio access network (RAN) nodes 170 and 170-1, and network element(s) 190 are illustrated. In FIG. 1, a user equipment (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a control module 140, comprising one of or both parts 140-1 and/or 140-2, which may be implemented in a number of ways. The control module 140 may be implemented in hardware as control module 140-1, such as being implemented as part of the one or more processors 120. The control module 140-1 may be implemented also as an integrated circuit or through other hardware such as a programmable gate array. In another example, the control module 140 may be implemented as control module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111 and with RAN node 170-1 via wireless link 111-1.

There are two RAN nodes 170, 170-1 illustrated, and the UE 110 can connect to either node (or both). In one example, the RAN node 170 is a serving gNB, or a serving cell (of a serving gNB). For ease of reference, this will be referred to in some examples as serving gNB/cell 170, serving gNB or serving cell. Similarly, the RAN node 170-1 is a target gNB, or a target cell (of a target gNB). For ease of reference, this will be referred to in some examples as target gNB/cell 170-1 or target gNB or target cell. Also, for ease of reference, both RAN nodes 170 and 170-1 are assumed to be similar and therefore only the circuitry in RAN node 170 is described here.

The RAN node 170 is a base station that provides access by wireless devices such as the UE 110 to the wireless network 100. The RAN node 170 may be, for instance, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface to a 5GC (e.g., the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of an RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a control module 150, comprising one of or both parts 150-1 and/or 150-2, which may be implemented in a number of ways. The control module 150 may be implemented in hardware as control module 150-1, such as being implemented as part of the one or more processors 152. The control module 150-1 may be implemented also as an integrated circuit or through other hardware such as a programmable gate array. In another example, the control module 150 may be implemented as control module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the control module 150 may be distributed, such as being distributed between the DU 195 and the CU 196, or be implemented solely in the DU 195.

The one or more network interfaces 161 communicate over a network such as via the links 176 and 131. Two or more RAN nodes 170, 170-1 communicate using, e.g., link 176. The link(s) 176 may be wired or wireless or both and may implement, e.g., an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, e.g., fiber optic cable or other suitable network connection to connect the other elements (e.g., a central unit (CU), gNB-CU) of the RAN node 170 to the RRH/DU 195. Reference 198 also indicates those suitable network link(s).

In certain examples, a gNB/cell notation is used. To address this, it is noted that description herein indicates that “cells” perform functions, but it should be clear that the base station that forms the cell will perform the functions. The cell makes up part of a base station. That is, there can be multiple cells per base station. For instance, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So, if there are three 120-degree cells per carrier and two carriers, then the base station has a total of 6 cells.

The wireless network 100 may include a network element or elements 190 that may include core network functionality, and which provides connectivity via a link or links 181 with a data network 191, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely exemplary functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, vehicles with a modem device for wireless V2X (vehicle-to-everything) communication, image capture devices such as digital cameras having wireless communication capabilities, gaming devices having wireless communication capabilities, music storage and playback appliances having wireless communication capabilities, Internet appliances (including Internet of Things, IoT, devices) permitting wireless Internet access and possibly browsing, IoT devices with sensors and/or actuators for automation applications with wireless communication tablets with wireless communication capabilities, as well as portable units or terminals that incorporate combinations of such functions.

Having thus introduced one suitable but non-limiting technical context for the practice of the exemplary embodiments, the exemplary embodiments will now be described with greater specificity.

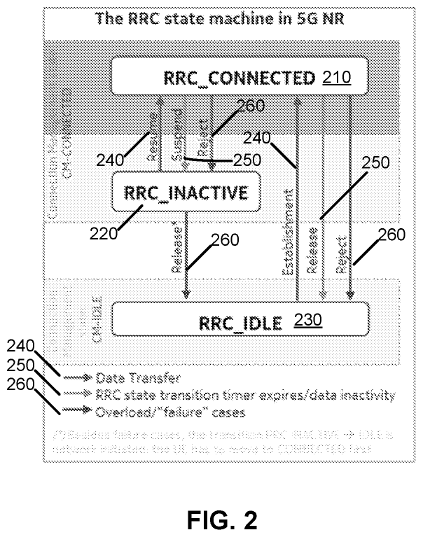

The exemplary embodiments herein relate to states of the UE, and in particular the RRC idle and inactive states. FIG. 2 is a block diagram of a NR (5G) state machine, including state transitions. In FIG. 2, there is an RRC connected state 210, which may also be referred to as RRC_CONNECTED or RRC CONNECTED or RRC Connected. There is an RRC inactive state 220, which may be referred to as RRC_INACTIVE or RRC INACTIVE or RRC Inactive. The final state is an RRC idle state 230, which may be referred to as RRC_IDLE or RRC IDLE or RRC Idle. There are transitions 240 involving data transfer, transitions 250, including RRC state transition time expiring or data inactivity, and transitions 260 that involve overload or “failure” cases. Also, note that “state” may be referred to as “mode”, such that the RRC Inactive state is the same as RRC Inactive mode.

The following transitions occur between the RRC_INACTIVE state 220 and RRC_CONNECTED state 210: a resume transition 240; a suspend transition 250; and a reject transition 260. The following transitions occur between the RRC_IDLE state 230 and the RRC_CONNECTED state 210: an establishment transition 240; a release transition 250; and a reject transition 260. There is a release transition 260 between the RRC_INACTIVE state 220 and the RRC_IDLE state 230.

Exemplary embodiments herein may relate to optimizations for UEs in the RRC Inactive or Idle states. While in one of the RRC Inactive or Idle states 220 or 230, the UE has to monitor regularly for paging. This is done according to the network defined paging cycles (e.g., the Inactive-DRX cycle of the UE in RRC inactive state 220). Rules are known at UE and network allowing to determine the right paging occasions (PO) based on a UE identifier (see 3GPP TS 36.304 and 3GPP TS 38.304). The UE identifier is known within the 5G-RAN, and thus the POs can be determined in the 5G-RAN to enable CN-level paging within the Tracking Area and RAN-level paging within the RAN Notification Area (RNA). However, before monitoring for paging in the POs, the UE has to perform tracking and downlink synchronization with the serving cell in time/frequency. In conventional techniques, RRC Inactive or Idle UEs have to perform these operations based on SSBs.

Moreover, transparently to the network, there may be UE mobility within the RNA while a UE is in RRC inactive, as in the following:

1) The location of a UE in RRC Inactive is only known at the RNA-level;

2) The UE provides a periodic RNA Update to notify its presence within the RNA; or

3) At the crossing of the RNA area, the UE also notifies such an event to the network.

Exemplary embodiments may also relate to mechanisms that should increase the sleep time of RRC Inactive UEs, by provisioning Tracking Reference Signals (TRS)/Channel-State Information Reference Signals (CSI-RS) for RRC_Inactive (and Idle) UEs that is to be defined during Rel-17 as part of Rel-17 WID on UE Power Saving Enhancements (RP-193239).

Among the many functions of TRS/CSI-RS in NR, in this context, these RSs support synchronization, time/frequency tracking for demodulation and reference signal received power (RSRP) measurements for mobility. The currently defined TRS/CSI-RS are applicable to RRC Connected state 210 only. Note that TRS is a resource set comprising multiple periodic CSI-RS. The TRS/CSI-RS are configured on a per-UE basis, but multiple UEs can share the same RS resources. NR supports a large flexibility in respect to the TRS/CSI-RS configuration. For instance, a resource can be configured with up to 32 ports, with a fully configurable density. In the time domain, a CSI-RS resource may start at any OFDM symbol of a slot and the resource spans 1, 2, or 4 OFDM symbols, depending on the number of ports configured. CSI-RS can be periodic, semi-persistent or aperiodic (DCI triggered). For the use case of time frequency tracking, CSI-RS may be periodic, or aperiodic, with a single port configured, and the signal being transmitted in bursts of two or four symbols spread over one or two slots.

The introduction of such TRS/CSI-RS provisioning for RRC Idle/Inactive UEs will provide flexibility and power saving for the UE for performing tracking and DL synchronization in time/frequency before paging monitoring. The UE will be able to use TRS/CSI-RS for idle and inactive mode that should be activated by a NG-RAN node a short time before the UE's paging cycle is due, i.e., shortly before the time the UE needs to wake up anyway for monitoring the paging occasion, leading to an increased sleep time for the UE and in turn to power saving. This way, the UE can avoid being awake for a number of (subsequent) SSB periods (which may not be even aligned with the paging cycles). Basically, the UE would find exactly the reference signals the UE needs to prepare for the paging monitoring and can use the TRS/CSI-RS in the same way it would have done with the SSBs.

There is a signaling overhead for the NG-RAN 170 associated with the provisioning of TRS/CSI-RS to UEs, as downlink radio resources may have to be set aside for this purpose. Therefore, assuming the NG-RAN nodes can afford to spend additional resources for the purpose of providing TRS/CSI-RS to RRC Inactive or Idle state UEs, these RSs have to be available in the right cell, at the right time, for the right UEs, and in the right amount to be useful for a UE. In order to be useful and support this UE power saving feature in the complete RNA of a UE, the NG-RAN should have to determine/know:

1) when the NG-RAN should provide these RSs (e.g., whenever a UE in RRC Inactive state requires them); and

2) in which cell(s) the NG-RAN should provide these RSs (e.g., in the cell where the UE is present).

For acquiring such knowledge and making the support of these additional RSs efficient, there needs to be some information provided by the UE and exchanged, e.g., over the Xn interface, related to the TRS/CSI-RS used for RRC Idle or Inactive mode UEs.

Furthermore, a UE with good SINR can handle the downlink synchronization with the serving cell typically based on one SSB burst, whereas a UE with low SINR has to process N (e.g., 3-8 subsequent) SSB bursts before a paging occasion (PO) to be sufficiently well synchronized with the network in the downlink Particularly, the decoding of PDSCH may be more sensitive to the synchronization due to the lower density of RSs in the PDSCH channel. This leads to a shorter sleep time. It also means that UEs with low SINR (or other radio quality metrics that may indicate a low radio channel quality) would benefit from an adequate number of additional TRS/CSI-RS to be provided before their POs, whereas these may not be of much benefit from these for UEs in good SINR. They may only cost additional network signaling.

Moreover, it is also an open question as to whether determining the presence of CSI-RS in 3GPP, e.g. as part of the Release-17, will be left up to a UE autonomous detection or there will be a network indication of TRS/CSI-RS presence (activation/deactivation), e.g., in SIB. The UE is assumed to be capable of detecting the presence of TRS/CSI-RS autonomously in quasi-colocation (QCL) scenarios based on the received SSB(s). The TRS/CSI-RSs can be expected to be sent with a close proximity in time to the SSB(s), with a fixed power offset compared to the SSB(s), and with a known (pseudo-)sequence. Also, it can be expected that the TRS/CSI-RS will be used by the UE, if they are detected to be strong enough, and otherwise they will be ignored. However, if the TRS/CSI-RS presence is not indicated by the network, either one of the options below might be performed.

1) The UE still has to wake up N SSB periods before the PO to ensure that the UE has downlink synchronization with the network to be ready for the PO also in the case that CSI-RSs are not present (to monitor for a paging DCI in the PDCCH during the PO and be able to decode an associated paging message in the PDSCH). This option leads to a reduced UE power saving potential.

2) The UE has to wake up in the last SSB before the PO, hoping for the presence of CSI-RSs. However, if CSI-RSs are not present/usable, the PO detection would likely fail, and the UE will be required to monitor additional SSBs before the synchronization is complete. In this option, the UE would need to be paged again at the cost of additional paging signaling and delay.

Both of these options are undesirable from signaling overhead and power saving perspectives.

Additionally, as part of NR, the concept of Quasi-Colocation (QCL) has been introduced. In general for this concept, two signals transmitted from the same antenna port experience the same radio channel, whereas if transmitted from two different antenna ports experience different radio conditions, e.g., in terms of Doppler Spread, Doppler Shift, average delay to receive all multipath components. However, there can be cases where two signals transmitted from two different antenna ports experience radio channels having common properties. In such cases, the antenna ports and the signals are said to be Quasi-Colocated (QCL). 3GPP has introduced this QCL concept to help the UE when performing procedures such as channel estimation, frequency offset error estimation, and synchronization. For example, if the UE knows that the radio channels corresponding to two different antenna ports is QCL in terms of Doppler shift, then the UE can determine the Doppler shift for one antenna port and then apply the result on both antenna ports for channel estimation, thus avoiding doppler calculations for both antenna port separately. See 3GPP TS 38.214, 5.1.5.

Concerning this, TRS/CSI-RS QCL to SSB may be assumed herein. In light of the description herein regarding the notion of QCL, this implies that the UE can measure the SSB(s) (transmitted on a given antenna port) and, based on that, the UE can infer/estimate properties related to the TRS/CSI-RS that are sent on a different antenna port. In other words, relying on the property that TRS/CSI-RS have Quasi-Colocation (QCL) with the SSB(s), the UE can perform some operations when measuring the SSBs, which are helpful (e.g. whose outcome can be reused) when measuring/processing the TRS/CSI-RS measurements.

Exemplary embodiments provide methods for the network to detect the presence in the coverage area of a cell of a UE in an RRC Inactive state 220 (e.g., or Idle state 230) that benefits from additional reference signals for its synchronization with the network because of poor radio quality, where the detection may be aided by UE assistance leveraging RRC Inactive (e.g., or Idle) operations. That is, UE assistance may be provided along with, e.g., RRC Inactive operations (e.g., related signaling). Specifically, the UE may provide to the network an indication of low radio quality (e.g., low SINR/RSRP/RSRQ, e.g., SINR/RSRP/RSRQ less than a threshold, or a quantized version of that SINR/RSRP/RSRQ) as “assistance” as part of, e.g., a RNA update procedure (which is UE-initiated). This process enables an efficient provisioning of TRS/CSI-RS before the paging occasions of the UE, based on the UE's radio quality metrics (such as SINR), which is indicative of the need and benefit of the UE from acquiring such additional TRS/CSI-RS as well as of their density, e.g., in time. Moreover, the TRS/CSI-RS configuration of the UE can be also tailored by the network based on the received SINR level.

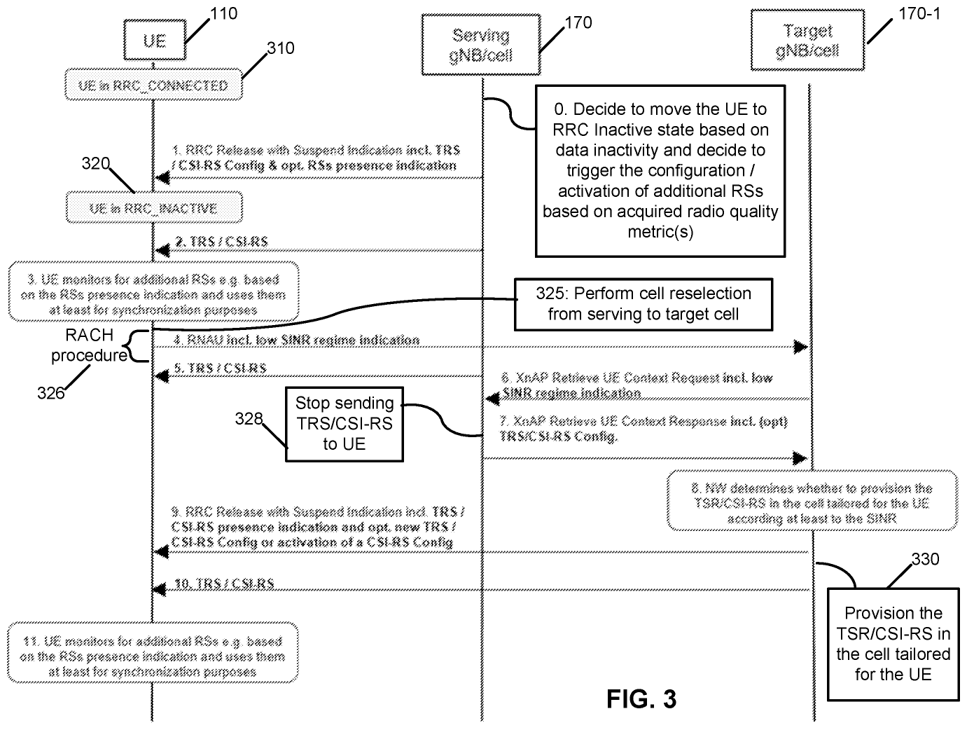

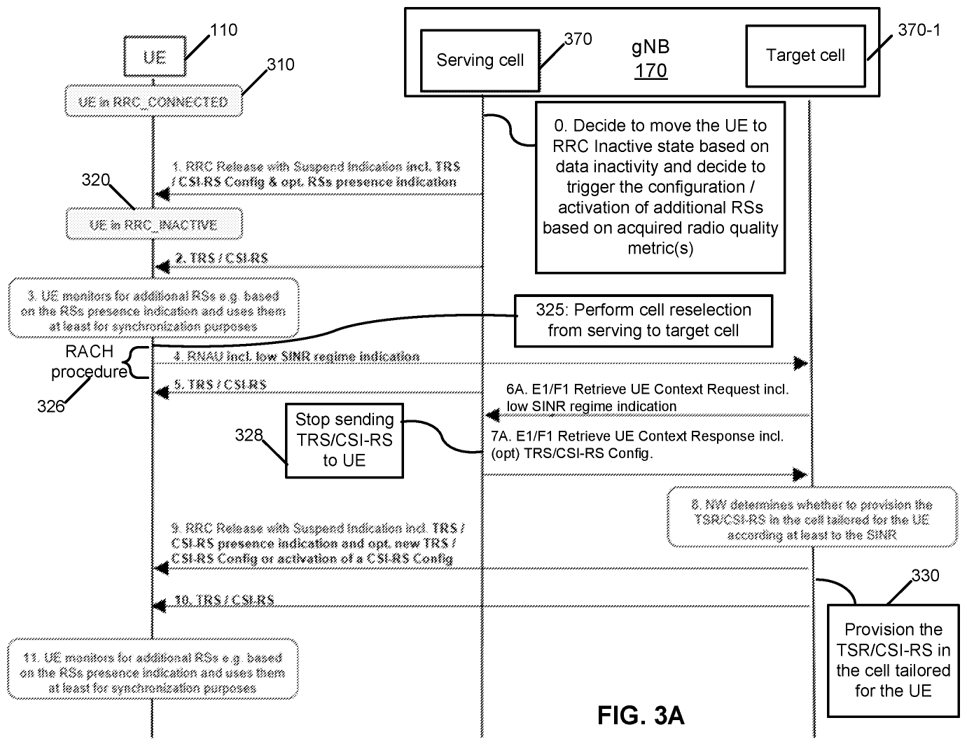

An exemplary proposed method is illustrated in FIG. 3 and comprises the steps described in the following. FIG. 3 illustrates the operation of an exemplary method or methods, a result of execution of computer program instructions embodied on a computer readable memory, functions performed by logic implemented in hardware, and/or interconnected means for performing functions in accordance with exemplary embodiments.

Furthermore, it is noted that new Information Elements (IEs) may be introduced in the signaling messages transferred over the Uu and Xn in order to enable this example, although other techniques are possible. In this example, a serving gNB/cell 170 is illustrated, as is a target gNB/cell 170-1. As described previously, a gNB typically forms multiple cells, and the serving or target cell is one of those cells for a corresponding gNB. In the description below, both the terms gNB and cell will be used.

While the UE is in RRC Connected state 210, the following steps are performed. In FIG. 3, reference 310 indicates that the UE is in RRC Connected state 210.

In step 0 (zero), the network decides to move the UE to RRC Inactive state based on e.g., data inactivity and decides to trigger the configuration/activation of additional RSs (TRS/CSI-RS reference signals belonging to the serving cell) based on acquired radio quality metric(s) for the UE such as the UE's RRM measurements performed by a UE in an RRC Inactive or Idle state, e.g. SINR (or a similar radio quality metric such as RSRP/RSRQ). For ease of reference, SINR is mainly used in the description below (and herein), but other radio quality metrics available at the UE might be used, or even a new dedicated metric defined for this purpose could be considered. Furthermore, emphasis is placed herein on the RRC Inactive state 220, but the operations described may also be applicable to the RRC Idle state 230.

The provisioning of the TRS/CSI-RS may be made as function of the UE SINR. The number of RSs and the configuration to be provided to the UE can also be determined based on the UE's SINR. For instance, a larger number of RSs can be provisioned for a low SINR UE, in terms of any of the following elements related to the TRS/CSI-RS configuration: density, number of ports, number of OFDM symbols, frequency domain allocation, and/or periodicity. It is also possible that even a UE with high SINR may be provisioned at least one TRS/CSI-RS.

In step 1, the UE 110 receives the RRC Release with Suspend Indication that moves the UE to the RRC Inactive state 220. The RRC Release with Suspend Indication message includes in this example TRS/CSI-RS configuration for use in RRC Inactive and optionally an additional RSs presence indication. In an example and non-limiting embodiment, the additional RSs may be configured/transmitted only for UEs in an RRC Inactive Idle state that have low SINR (e.g., or other radio quality deemed to be low), because these UEs can benefit more from the additional RSs. In this example, because the UE has low SINR (or other equivalent radio quality), the network transmits optionally additional RSs presence indication and the additional RSs themselves.

While the UE is in RRC Inactive state 220, the following steps are performed. Note that reference 320 indicates the UE 110 is in the RRC Inactive state 220.

In step 2, the serving cell 170 transmits TRS/CSI-RS for the UE e.g., periodically and according to the UE's Paging Occasion (PO). Thus, it is noted that the serving cell 170 sends the TRS/CSI-RS also in step 5. The relationship between RS and PO could be defined in various manners. Consider the following non-limiting set of options:

Option 1: the network indicates the exact timing of the RSs before the PO (e.g., the exact slots/OFDM symbols where the RSs will (may) be transmitted are configured/indicated). The exact timing could be provided, in one example, as a delta versus the timing of the first PO (paging occasion) in a PF (paging frame). In another example, the exact timing could be provided as delta to the SSBs before the PO.

Option 2: the network indicates a time window (e.g., via a start and/or an end) in which the RSs will (may) be transmitted before the PO. The window timing could be provided, in an example, in respect to the SSBs before the PO.

Option 3: the network indicates only the presence of the RSs before the PO with no further information on their exact location in time.

Option 4: the network does not indicate anything and simply may transmit the RSs. The UE autonomously detect their presence. However, their location in time may be still connected to the locations of the SSBs.

In step 3, the UE in the RRC Inactive state 220 monitors for additional RSs, e.g., based on the received additional RSs configuration and (possible) presence indication and uses them at least for synchronization purposes. These additional RSs correspond to the TRS/CSI-RS that the network transmits to aid the UE in its synchronization effort. The term “additional” is used as these RSs (TRS/CSI-RS) complement the RSs already configured/transmitted (e.g., such as in the SSBs as one example).

In an example embodiment, the amount/density and the purpose and use of TRS/CSI-RSs may be different depending on the RRC state. For instance, in the RRC Connected state 210, the configuration of TRS/CSI-RS is primarily intended for the network to learn about the radio environment as seen by the UE. That is, the UE reporting of the CSI-RS measurements (i.e. measured from the CSI-RS transmitted by the network) are useful e.g. for scheduling and link adaptation decisions at the network.

On the contrary, the configuration of TRS/CSI-RS for use in the RRC Inactive or Idle state may have a different purpose. This purpose is to help the UE to acquire and/or maintain synchronization with the network for the UE to be ready, e.g., to monitor a paging DCI on PDCCH and a paging message in the PDSCH in a paging occasion. Therefore, these TRS/CSI-RSs may be sent “just before” (e.g., with a known/indicated time period from) the paging occasion of the UE. The additional RSs may also be denser (e.g., in terms of TRS/CSI-RS per time period) than those used for RRC Connected. The synchronization may be been lost because in RRC Inactive or Idle state, the UE may sleep for a long time (paging cycles are in the order of seconds, 1.28 seconds typically). This synchronization issue is typically not present in RRC Connected mode 210, in which the UE may not be sleeping for long periods and therefore may not lose synchronization with the network.

It is further noted that, in principle, these additional RSs intended for RRC Inactive or Idle state could still be used after the UE transitions to RRC Connected mode, e.g., if the network allows/indicates that. As described above, however, these RSs are tailored for acquiring synchronization with the network, thus there may not be a big need for them in RRC Connected mode, in which the UE may be capable of maintaining synchronization with the network. However, these may be still useful in RRC Connected mode in certain scenarios, e.g. where the DRX cycle is large.

In block 325, the UE 110 performs a cell reselection from the (old) serving cell to the (new) target cell. An RNA update, RNAU (RAN Notification Area, RNA, update), is then sent to the cell in which the UE is currently camping (i.e., the target cell).

Consequently, in step 4, the UE in the RRC Inactive state 220 may send an indication of low SINR along with, e.g., the RNAU. The indication of low SINR could be an indication of an SINR value/range, or an indication of “low SINR”, and in an example an indication that SINR is less than a network-defined threshold. Concerning “low” radio quality metrics, a “low” metric could be a selected/configured metric that is less than a (e.g., configured) threshold, where examples of radio metrics for UEs in RRC Inactive or Idle state can be DL SINR, (DL) RSRP, or (DL) RSRQ. For maintaining/acquiring DL synchronization with the network, the UE estimates time/frequency (synchronization) errors (i.e., the deviation from the actual/nominal time/frequency) based on comparing RSs sampled at different times. Basically, the UE attempts to discriminate these errors (e.g., caused due to time/frequency drift of the local oscillator) from the radio changes of the channel (e.g., due to noise and/or fast fading). In general, the higher the UE's associated DL signals SINR (RSRP/RSRQ), the better is the capability of the UE to discriminate between synchronization errors and, e.g., noise and, in turn, the fewer samples the UE will need to compare, which means the NW can send fewer RSs in time.

It is noted, in an example, that the RNAU message may be sent via a random access procedure 326, where in Msg3 of a 4-step RACH procedure 326 or in MSGA of a 2-step RACH procedure 326, the UE sends a RRC Resume Request whose Resume Cause value is set to RNAU.

The presence of the low SINR indication (or an indication of radio quality metric(s) being deemed to be low) can be indicated in a radio protocol header (e.g., MAC header) or a message with a resume cause. This can be generalized such that the UE could provide the indication also if no other triggers are met (e.g., among a trigger for the periodic RNAU, a resume trigger after being paged by the network, or a resume triggered due to UL data present in the UE's buffer).

Alternatively or additionally to step 4, the UE could indicate the need for and/or a request of additional reference signals. In one aspect, this indication is to be provided irrespective whether the UE is currently configured with TRS/CSI-RS for use in RRC Inactive state 220 or not.

In one more aspect, the UE could indicate no need for the additional reference signals. This could be indicated, for example, by a UE having a sufficiently high SINR. In another aspect, this indication is to be provided only if the UE is currently configured with TRS/CSI-RS for use in RRC Inactive mode 220.

Alternatively or additionally, when the UE is experiencing better SINR conditions for a specific amount of monitoring time (which may be defined by the network), the UE can indicate in the following RNAU (e.g., one sent after step 4) that the UE either no longer needs the TRS/CSI-RS or needs a lower number of TRS/CSI-RSs.

Furthermore, if the UE SINR conditions worsen for a specific amount of monitoring time, the UE can trigger an earlier RNAU (or other message) where the UE will inform the NW about the need for additional TRS/CSI-RS.

In step 5, the serving cell 170 sends additional TRS/CSI-RS, in accordance with the configuration previously sent.

In step 6, the gNB of the cell receiving the RNAU request from the UE (in this example, the target cell 170-1) provides the SINR indication to the anchor gNB as part of the XnAP Retrieve UE Context Request, which may indicate RNAU as cause for the request. The anchor gNB is the serving gNB 170.

In response to receiving the XnAP Retrieve UE Context Request, the serving cell 170 stops sending the TRS/CSI-RS to the UE. This occurs in block 328.

In step 7, upon receiving a XnAP Retrieve UE Context Request, the anchor gNB 170 stops provisioning TRS/CSI-RS for the UE (as the request serves as indication that the UE is not any longer under its coverage area) and will respond to the target gNB providing, optionally, the current TRS/CSI-RS configuration of the UE.

In certain alternative implementations, the decision to continue to transmit the TRS/CSI-RS could be based on the condition of multiple UEs, e.g., being present within the cell and correspondingly the TRS/CSI-RS could be provisioned to multiple UEs.

In step 8, the receiving cell (referred to as the NW, network), in this case the target cell 170-1, determines whether to provision the TRS/CSI-RS tailored for the UE (just before its POs) according to the SINR indication. The provisioning may be made as function of the SINR, such as if the indication indicated low SINR. In one aspect, the same/current TRS/CSI-RS Config is retained at the target cell 170-1. In another aspect, the number of RSs and potentially the configuration to be provided to a UE is (or are) determined based on the UE's SINR. In yet another aspect, the number of RSs and potentially the configuration to be provided to a UE is determined based on indications/radio quality metrics of multiple UEs.

In step 9, the target cell 170-1 provides to the UE 110 additional RSs configuration (e.g., as the activation of the TRS/CSI-RS Config) and (possible) indication of “presence/absence of TSR/CSI-RS” in response to the UE's RNAU for a certain time T_RSpresence.

In block 330, the receiving cell starts provisions the TSR/CSI-RS in the cell tailored for the UE (just before its POs). Consequently, in step 10, the target cell 170-1 sends the TRS/CSI-RS to the UE 110.

In step 11, the UE monitors for additional RSs, e.g., based on the received additional RSs presence indication and uses them at least for synchronization purposes.

FIG. 3A is an exemplary signaling flow similar to FIG. 3, but where the serving and target cells are both in (and formed by) a single gNB, in an exemplary embodiment. FIG. 3A illustrates the operation of an exemplary method or methods, a result of execution of computer program instructions embodied on a computer readable memory, functions performed by logic implemented in hardware, and/or interconnected means for performing functions in accordance with exemplary embodiments.

This example has a serving cell 370 and a target cell 370-1 being in and formed by a single gNB 170. The exemplary signaling sequence in FIG. 3A is similar to the sequence in FIG. 3, but step 6 of FIG. 3 is now step 6A of FIG. 3A, and is performed over the E1/F1 interface. Similarly, step 7 of FIG. 3 is now step 7A of FIG. 3A, and is performed over the E1/F1 interface.

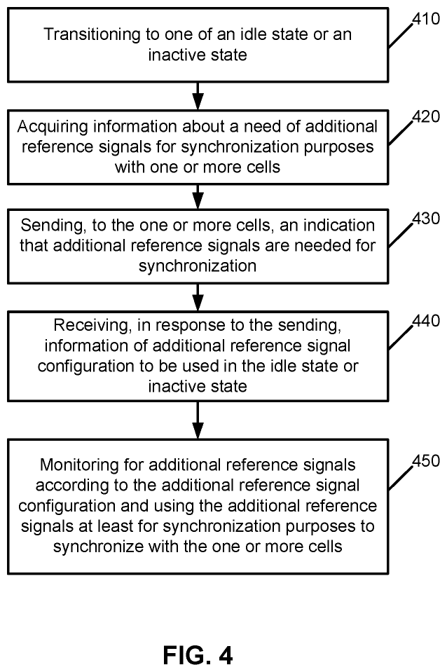

Turning to FIG. 4, this figure illustrates a method performed by a user equipment in accordance with the techniques presented above. This figure further illustrates the operation of an exemplary method or methods, a result of execution of computer program instructions embodied on a computer readable memory, functions performed by logic implemented in hardware, and/or interconnected means for performing functions in accordance with exemplary embodiments. For instance, the control module 140 may include multiples ones of the blocks in FIG. 4, where each included block is an interconnected means for performing the function in the block. The blocks in FIG. 4 are assumed to be performed by the UE 110, e.g., under control of the control module 140 at least in part.

In block 410, the user equipment performs transitioning to one of an idle state or an inactive state. In block 420, the user equipment 110 performs acquiring information about a need of additional reference signals for synchronization purposes with one or more cells. The user equipment, in block 430, performs sending, to the one or more cells, an indication that additional reference signals are needed for synchronization. The user equipment, in block 440, performs receiving, in response to the sending, information of additional reference signal configuration to be used in the idle state or inactive state. In block 450, the user equipment 110 performs monitoring by the user equipment for additional reference signals according to the additional reference signal configuration and using the additional reference signals at least for synchronization purposes to synchronize with the one or more cells.

The following are additional examples. In these examples, the flowchart of FIG. 4 is referred to as example. 1.

Example 2. The method of example 1, wherein:

the acquiring information is performed at least by determining by the user equipment that one or more radio quality metrics are deemed to be low; and

the sending the indication that additional reference signals are needed for synchronization is in response to the determination by the user equipment that the one or more radio quality metrics are deemed to be low.

Example 3. The method of example 2, wherein:

the sending the indication that additional reference signals are needed for synchronization comprises sending an indication of the one or more radio quality metrics being deemed to be low.

Example 4. The method of any one of examples 1 to 3, wherein the indication that additional reference signals are needed for synchronization is sent in a radio notification area update message.

Example 5. The method of any one of examples 1 to 4, wherein the indication that additional reference signals are needed for synchronization is sent in a random access procedure.

Example 6. The method of any one of the examples above, wherein the one or more radio quality metrics comprise one or more of SINR, RSRP, or RSRQ.

Example 7. The method of any one of the examples above, wherein the additional reference signals comprise one or more of tracking reference signals and/or channel state information reference signals.

Example 8. The method of example 7, wherein the using the additional reference signals at least for synchronization purposes to synchronize with the one or more cells comprises using by the user equipment the additional reference signals to synchronize with at least one of the one or more cells in order to be ready to monitor for a paging indication and/or a paging message in a paging occasion for the at least one cell.

Example 9. The method of any one of the examples above, wherein using the additional reference signals at least for synchronization comprises using the additional reference signals for time and/or frequency error offset estimation and/or for tracking for demodulation and/or for reference signal received power measurements for mobility.

Example 10. The method of any one of the examples above, further comprising the user equipment ignoring the additional reference signals in response to radio link quality at the user equipment being determined to be high.

Example 11. The method of example any one of the examples above, wherein the information of additional reference signal configuration comprises one or both of indication of reference signal configuration or an indication that reference signals will be present in transmissions by at least one of the one or more cells.

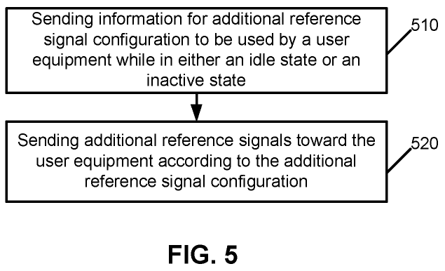

Turning to FIG. 5, this figure is a logic flow diagram performed by a cell, as controlled by a gNB 170/170-1. This figure further illustrates the operation of an exemplary method or methods, a result of execution of computer program instructions embodied on a computer readable memory, functions performed by logic implemented in hardware, and/or interconnected means for performing functions in accordance with exemplary embodiments. For instance, the control module 150 may include multiples ones of the blocks in FIG. 5, where each included block is an interconnected means for performing the function in the block. The blocks in FIG. 5 are assumed to be performed by a base station or other network node such as RAN node 170/170-1 (which may be a gNB in examples), e.g., under control of the control module 150 at least in part. For ease of reference, a “cell” is used as the entity performing the flow.

In block 510, the cell performs sending information of additional reference signal configuration to be used by a user equipment while in either an idle state or an inactive state. In block 520, the cell performs sending additional reference signals toward the user equipment according to the additional reference signal configuration.

The following are additional examples. In these examples, the flow in FIG. 5 is referred to as example 12.

Example 13. The method of example 12, wherein the information of additional reference signal configuration comprises one or both of indication of reference signal configuration or an indication that reference signals will be present in transmissions by the cell.

Example 14. The method of either example 12 or 13, wherein the cell is a serving cell and wherein the method further comprises causing, by the serving cell, the user equipment to transition to one of the idle state or the inactive state.

Example 15. The method of example 14, wherein:

the sending by the serving cell additional reference signals toward the user equipment is performed prior to the user equipment entering the selected one of the idle state or the inactive state.

Example 16. The method of either example 14 or 15, wherein:

the sending by the serving cell additional reference signals toward the user equipment is performed prior to transmission by the serving cell of a paging occasion toward the user equipment.

Example 17. The method of example 14, wherein the method further comprises:

receiving by the serving cell a request from a target cell for context for the user equipment; and

stopping, in response to the request, the sending the additional reference signals toward the user equipment.

Example 18. The method of any one of examples 14 to 17, further comprising sending, responsive to the request and from the serving cell toward the target cell, information of the additional reference signal configuration used by the user equipment in the serving cell while in either the idle state or the inactive state.

Example 19. The method of example 12, wherein:

the method comprises receiving, at the cell and from the user equipment in one of the idle or inactive state, an indication of additional reference signals being needed for synchronization; and

the sending the additional reference signals is performed responsive to the receiving the indication of additional reference signals being needed for synchronization;

Example 19A. The method of example 19, wherein the indication of additional reference signals being needed for synchronization comprises an indication of the one or more radio quality metrics being deemed to be low.

Example 20. The method of example 19 or 19A, wherein the cell is a target cell, the method further comprises sending, by the target cell and to a serving cell and in response to the indication of additional reference signals being needed for synchronization, a message indicating the indication from the user equipment of additional reference signals being needed for synchronization.

Example 21. The method of example 20, further comprising the target cell receiving information of a configuration of additional reference signal configuration used by the serving cell for the user equipment and wherein the information of the additional reference signal configuration to be used by the user equipment in the idle or inactive state is based also on the information of the configuration of the additional reference signals used by the serving cell for the user equipment.

Example 22. The method of example 21, wherein the message sent by the target cell and to the serving cell also indicates a request for context of the user equipment from the serving cell, and wherein the information of the configuration of the additional reference signals used by the serving cell for the user equipment is received along with information of context of the user equipment.

Example 23. The method of any one of examples 20 to 22, wherein the sending by the target cell comprises sending the information of the additional reference signal configuration to be used by the user equipment in the idle or inactive state using a radio resource control message.

Example 24. The method of example 23, wherein the radio resource control message comprises a radio resource control release message with suspend indication.

Example 25. The method of any one of examples 19 to 24, wherein sending by the target cell information of the additional reference signal configuration further comprises sending an indication that additional reference signal configuration already configured for the user equipment should be activated.

Further examples are as follows.

Example 26. A computer program, comprising code for performing the methods of any of examples 1 to 25, when the computer program is run on a computer.

Example 27. The computer program according to example 26, wherein the computer program is a computer program product comprising a computer-readable medium bearing computer program code embodied therein for use with the computer.

Example 28. The computer program according to example 26, wherein the computer program is directly loadable into an internal memory of the computer.

Example 29. An apparatus comprising means for performing:

transitioning by the user equipment to one of an idle state or an inactive state;

acquiring information by the user equipment about a need of additional reference signals for synchronization purposes with one or more cells;

sending, by the user equipment and to the one or more cells, an indication that additional reference signals are needed for synchronization;

receiving, in the user equipment and in response to the sending, information of additional reference signal configuration to be used in the idle state or inactive state; and

monitoring by the user equipment for additional reference signals according to the additional reference signal configuration and using the additional reference signals at least for synchronization purposes to synchronize with the one or more cells.

Example 30. An apparatus comprising means for performing:

sending, by a cell in a wireless network, information of additional reference signal configuration to be used by a user equipment while in either an idle state or an inactive state; and

sending by the cell additional reference signals toward the user equipment according to the additional reference signal configuration.

Example 31. An apparatus, comprising:

one or more processors; and

one or more memories including computer program code,

wherein the one or more memories and the computer program code are configured, with the one or more processors, to cause the apparatus to perform operations comprising:

transitioning by the user equipment to one of an idle state or an inactive state;

acquiring information by the user equipment about a need of additional reference signals for synchronization purposes with one or more cells;

sending, by the user equipment and to the one or more cells, an indication that additional reference signals are needed for synchronization;

receiving, in the user equipment and in response to the sending, information of additional reference signal configuration to be used in the idle state or inactive state; and

monitoring by the user equipment for additional reference signals according to the additional reference signal configuration and using the additional reference signals at least for synchronization purposes to synchronize with the one or more cells.

Example 32. An apparatus, comprising:

one or more processors; and

one or more memories including computer program code,

wherein the one or more memories and the computer program code are configured, with the one or more processors, to cause the apparatus to perform operations comprising:

sending, by a cell in a wireless network, information of additional reference signal configuration to be used by a user equipment while in either an idle state or an inactive state; and

sending by the cell additional reference signals toward the user equipment according to the additional reference signal configuration.

Example 33. A computer program product comprising a computer-readable storage medium bearing computer program code embodied therein for use with a computer, the computer program code comprising:

code for transitioning by the user equipment to one of an idle state or an inactive state;

code for acquiring information by the user equipment about a need of additional reference signals for synchronization purposes with one or more cells;

code for sending, by the user equipment and to the one or more cells, an indication that additional reference signals are needed for synchronization;

code for receiving, in the user equipment and in response to the sending, information of additional reference signal configuration to be used in the idle state or inactive state; and

code for monitoring by the user equipment for additional reference signals according to the additional reference signal configuration and using the additional reference signals at least for synchronization purposes to synchronize with the one or more cells.

Example 34. A computer program product comprising a computer-readable storage medium bearing computer program code embodied therein for use with a computer, the computer program code comprising:

sending, by a cell in a wireless network, information of additional reference signal configuration to be used by a user equipment while in either an idle state or an inactive state; and

sending by the cell additional reference signals toward the user equipment according to the additional reference signal configuration.

As described above, the exemplary embodiments allow acquiring, e.g., by the UE and exchange in the network, knowledge related to the actual need/benefit of a UE in RRC Idle or Inactive state of receiving additional RSs as well as, in some exemplary embodiments, knowledge related to the time/frequency density of the RSs. This allows providing, e.g., TRS/CSI-RS used for RRC Idle or Inactive state UEs efficiently, such as only whenever a UE in RRC Inactive or Idle state requires them (e.g., has a low SINR or indicates the need based, e.g., on the internal knowledge of its synchronization capability/algorithms and the acquired radio channel conditions) and in an amount which is adequate to speed up the UE synchronization based on the given UE capability/conditions, and in turn saving power. It is remarked that the TRS/CSI-RS, when activated for this purpose, can be shared by multiple UEs that share the same/close PO periodicity.

As used in this application, the term “circuitry” may refer to one or more or all of the following:

(a) hardware-only circuit implementations (such as implementations in only analog and/or digital circuitry) and

(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
3GPP third generation partnership project
5G fifth generation
5GC 5G core network
AMF access and mobility management function
BWP Bandwidth Part
Config. configuration
CP Control Plane
CQI Channel Quality Indicator
CSI Channel-state information
CSI-RS Channel-State Information Reference Signals
CU central unit
DCI Downlink Control Channel
DRX Discontinuous reception
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
gNB (or gNodeB) base station for 5G/NR, i.e., a node providing NR user plane and control plane protocol terminations towards the UE, and connected via the NG interface to the 5GC
IE information element
I/F interface
incl. including
I-RNTI Inactive-RNTI
LTE long term evolution
MAC medium access control
MME mobility management entity
ng or NG next generation
NG-5G-S-TMSI 5G S-Temporary Mobile Subscriber Identity
ng-eNB or NG-eNB next generation eNB
NR new radio
NG-RAN New Generation-Radio Access Network
N/W or NW network
OFDM orthogonal frequency-division multiplexing
opt. optional
PCell Primary Cell
PDCCH Physical Downlink Control Channel
PDCP packet data convergence protocol
PDSCH Physical downlink shared channel
PHY physical layer
PO Paging Occasion
PRACH Physical Random Access Channel
PRB physical resource block
PUCCH Physical Uplink Control Channel
PUSCH Physical Uplink shared channel
PS-RNTI Power saving-RNTI
QCL Quasi-Colocation or Quasi-Colocated
RA Random Access
RACH Random Access Channel
RAN radio access network
Rel release
RLC radio link control
RNA RAN Notification Area
RNAU RAN Notification Area Update
RNTI Radio Network Temporary Identifier
RRH remote radio head
RRC radio resource control
RRM Radio resource management
RS reference signal
RSRP Reference Signal Received Power
RSRQ Reference Signal Received Quality
RU radio unit
Rx receiver
SDAP service data adaptation protocol
SGW serving gateway
SI System Information
SIB System Information Block
SINR Signal to Interference plus Noise Ratio
SMF session management function
SSB Synchronization Signal Block
TA Time Alignment
TRS Tracking Reference Signals
TS technical specification
Tx transmitter
UE user equipment (e.g., a wireless, typically mobile device)
UP User Plane
UPF user plane function
Uu Radio interface
WUS Wake-Up Signal
Xn Network interface across gNBs

1-56. (canceled)

57. A method performed by a user equipment, comprising:
transitioning to one of an idle state or an inactive state;
acquiring information about a need of additional reference signals for synchronization purposes with a cell;
sending, to the cell, an indication that additional reference signals are needed for synchronization;
receiving, in response to the sending, information of additional reference signal configuration to be used in the idle state or inactive state; and
monitoring for additional reference signals according to the additional reference signal configuration and using the additional reference signals at least for synchronization purposes to synchronize with the cell.

58. An apparatus comprising:
at least one processor; and
at least one memory storing instructions that, when executed by the at least one processor, cause the apparatus at least to:
transition to one of an idle state or an inactive state;
acquire information about a need of additional reference signals for synchronization purposes with a cell;
send to the cell, an indication that additional reference signals are needed for synchronization;
receive, in response to the sending, information of additional reference signal configuration to be used in the idle state or inactive state; and
monitor for additional reference signals according to the additional reference signal configuration and use the additional reference signals at least for synchronization purposes to synchronize with the cell.

59. The apparatus of claim 58, wherein:
the acquiring information is performed at least by determining that one or more radio quality metrics are deemed to be low; and
the sending the indication that additional reference signals are needed for synchronization is in response to the determination that the one or more radio quality metrics are deemed to be low.

60. The apparatus of claim 59, wherein:
the sending the indication that additional reference signals are needed for synchronization comprises sending an indication of the one or more radio quality metrics being deemed to be low.

61. The apparatus of claim 59, wherein the one or more radio quality metrics comprise one or more of signal to interference plus noise ratio, reference signal received power, or reference signal received quality.

62. The apparatus of claim 58, wherein the indication that additional reference signals are needed for synchronization is sent in a radio notification area update message, or in a random access procedure.

63. The apparatus of claim 58, wherein the additional reference signals comprise one or more of tracking reference signals or channel state information reference signals.

64. The apparatus of claim 58, wherein the using the additional reference signals at least for synchronization purposes to synchronize with the cell comprises at least one of using the additional reference signals to synchronize with the cell in order to be ready to monitor for a paging indication or a paging message in a paging occasion for the cell or using the additional reference signals for time or frequency error offset estimation, for tracking for demodulation, or for reference signal received power measurements for mobility.

65. The apparatus of claim 58, wherein the instructions, when executed by the at least one processor, cause the apparatus further to: ignore the additional reference signals in response to radio link quality at the apparatus being determined to be high.

66. The apparatus of claim 58, wherein the information of additional reference signal configuration comprises one or both of an indication of reference signal configuration or an indication that additional reference signals will be present in transmissions of the cell.

67. An apparatus comprising:
at least one processor; and
at least one memory storing instructions that, when executed by the at least one processor, cause the apparatus at least to:
send information of additional reference signal configuration to be used by a user equipment while in either an idle state or an inactive state; and
send additional reference signals toward the user equipment according to the additional reference signal configuration.

68. The apparatus of claim 67, wherein the information of additional reference signal configuration comprises one or both of an indication of reference signal configuration or an indication that additional reference signals will be present in transmissions of the cell.

69. The apparatus of claim 67, wherein the cell is a serving cell, and wherein the instructions, when executed by the at least one processor, cause the apparatus further to: cause the user equipment to transition to one of the idle state or the inactive state.

70. The apparatus of claim 69, wherein:
the sending additional reference signals toward the user equipment is performed prior to the user equipment entering the selected one of the idle state or the inactive state.

71. The apparatus of claim 69, wherein:
the sending additional reference signals toward the user equipment is performed prior to transmission of a paging occasion toward the user equipment.

72. The apparatus of claim 69, wherein the instructions, when executed by the at least one processor, cause the apparatus further to:
receive a request from a target cell for context for the user equipment; and
stop, in response to the request, the sending the additional reference signals toward the user equipment.

73. The apparatus of claim 72, wherein the instructions, when executed by the at least one processor, cause the apparatus further to: send, responsive to the request and toward the target cell, information of the additional reference signal configuration used by the user equipment in the serving cell while in either the idle state or the inactive state.

74. The apparatus of claim 67, wherein the instructions, when executed by the at least one processor, cause the apparatus further to:
receive, from the user equipment in one of the idle or inactive state, an indication of additional reference signals being needed for synchronization; and
the sending the additional reference signals is performed in responsive to the receiving the indication of additional reference signals being needed for synchronization.

75. The apparatus of claim 74, wherein the cell is a target cell, and wherein the instructions, when executed by the at least one processor, cause the apparatus further to: send to a serving cell and in response to the indication of additional reference signals being needed for synchronization, a message indicating the indication from the user equipment of additional reference signals being needed for synchronization.

76. The apparatus of claim 75, wherein the instructions, when executed by the at least one processor, cause the apparatus further to: receive information of a configuration of additional reference signal used by the serving cell for the user equipment and wherein the information of the additional reference signal configuration to be used by the user equipment in the idle or inactive state is based also on the information of the configuration of the additional reference signals used by the serving cell for the user equipment.
